(19) United States
(12) Patent Application Publication
(10) Pub. No.: US 2011/0168924 A1
(43) Pub. Date: Jul. 14, 2011

(54) CHARGE ALTERATION USING ULTRAVIOLET RADIATION

(76) Inventors: Richard M. Jendrejack, Hudson, WI (US); David L. Phillips, White Bear Lake, MN (US); Mitchell A.F. Johnson, Maplewood, MN (US); Peter T. Benson, North St. Paul, MN (US)

(21) Appl. No.: 12/808,699

(22) PCT Filed: Dec. 16, 2008
(86) PCT No.: PCT/US08/86958

§ 371 Date: Jun. 17, 2010

Related U.S. Application Data
(60) Provisional application No. 61/015,950, filed on Dec. 21, 2007.

(51) Int. Cl. H05F 3/06

(52) U.S. Cl. 250/492.1

(57) ABSTRACT

A system(109) for altering charge of a dielectric material (90) uses ultraviolet radiation. The system includes a gas source (102) and an ultraviolet radiation source (104). The gas source (102) introduced a gas (103) to a region adjacent the dielectric material (90). The ultraviolet radiation source (104) is arranged to irradiate the region to adjust charge on the dielectric material. A method of altering charge on a dielectric material (90) is also disclosed in which a gas (103) is introduced to a region adjacent the dielectric materia (90)1. The region is then irradiated with the ultraviolet radiation (105) to alter charge on the dielectric material (90).

### BACKGROUND

Static charge buildup often occurs on dielectric materials. When a dielectric material comes into contact with another material, an exchange of surface charge occurs. When these materials are then separated, some of the exchanged charge may remain on one or both of the materials. The amount of charge remaining depends on the respective material properties as well as external factors such as humidity or applied electric fields.

Due to the low conductivity of a dielectric material, charge remaining on the dielectric material becomes at least temporarily trapped on the surface until it either bleeds off to ground or is neutralized by an external source such as an ionizer or by ambient ions in the air. Static charge on a dielectric material can lead to various problems, including coating defects. A discharge of static electricity from the dielectric material can lead to additional problems.

### SUMMARY

In general terms, this patent is directed to alteration of charge of a dielectric material using ultraviolet radiation. In one possible configuration and by non-limiting example, charge alteration involves an ultraviolet radiation source and a gas source. Gas from the gas source is introduced adjacent to a charged dielectric material. Ultraviolet radiation from the ultraviolet radiation source is provided to the interface between the gas and the dielectric material to alter the charge present on the dielectric material.

One aspect is a charge alteration system for altering a charge on a dielectric material, the system comprising a gas source for introducing a gas to a location adjacent the dielectric material such that the gas has a greater concentration at the location than in atmosphere; and an ultraviolet radiation source for generating ultraviolet radiation and directing the ultraviolet radiation to the location; wherein the ultraviolet radiation interacts with the gas and the dielectric material to alter the charge on the dielectric material.

Another aspect is a method of altering charge on a dielectric material, the method comprising obtaining the dielectric material; introducing a gas to a region adjacent the dielectric material such that the gas has a greater concentration at the region than in atmosphere; irradiating the region and the dielectric material with ultraviolet radiation; and altering charge on the dielectric material while irradiating the dielectric material.

Yet another aspect is a charge alteration system comprising a dielectric material path for receiving a dielectric material; a gas source containing a gas, the gas source arranged to supply the gas to a location adjacent the dielectric material path to increase a concentration of the gas at the location; and an ultraviolet radiation source for radiating the location with ultraviolet radiation to excite the gas and to alter charge on the dielectric material.

### BRIEF DESCRIPTION OF THE DRAWINGS

FIG. 1 is a block diagram of an exemplary charge alteration system for altering a charge on a dielectric material according to the present disclosure.

FIG. 2 is another block diagram of an exemplary charge alteration system according to the present disclosure.

FIG. 3 is a block diagram of another exemplary charge alteration system according to the present disclosure.

FIG. 4 is a block diagram of another exemplary charge alteration system according to the present disclosure.

FIG. 5 is a block diagram of another exemplary charge alteration system according to the present disclosure.

FIG. 6 is a block diagram of another exemplary charge alteration system according to the present disclosure.

FIG. 7 is a schematic block diagram of a test system used to conduct experiments according to the present disclosure.

FIG. 8 is a bar graph illustrating test results achieved for positively charged dielectric material using nitrogen and the test system shown in FIG. 7.

FIG. 9 is a bar graph illustrating test results achieved for negatively charged dielectric material using nitrogen and the test system shown in FIG. 7.

FIG. 10 is a timeline further illustrating measurements of the test results shown in FIG. 8.

FIG. 11 is a graph illustrating test results achieved using nitrogen and the test system shown in FIG. 7.

FIG. 12 is a graph illustrating test results achieved using nitrogen and the test system shown in FIG. 7.

FIG. 13 is a graph illustrating test results achieved using carbon dioxide and the test system shown in FIG. 7.

FIG. 14 is a graph illustrating test results achieved using argon and the test system shown in FIG. 7.

FIG. 15 is a graph illustrating test results achieved using argon and the test system shown in FIG. 7.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

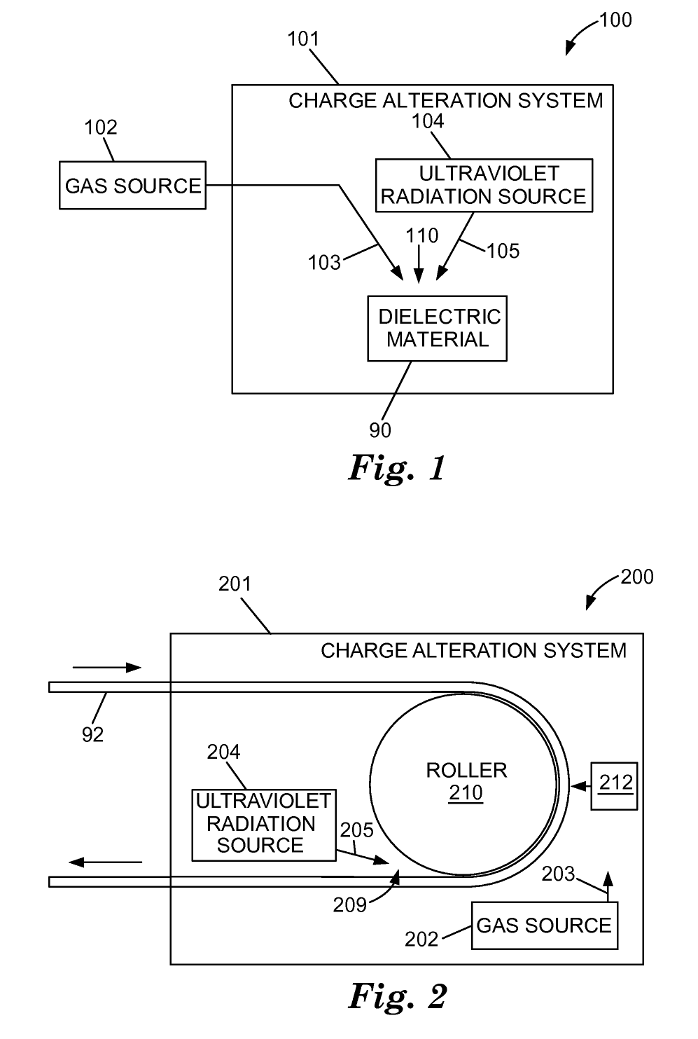

FIG. 1 is a block diagram of an exemplary charge alteration system 100 for altering a charge on a dielectric material 90. Charge alteration system 100 includes housing 101, gas source 102 and ultraviolet radiation source 104. Gas source 102 is a source of gas 103. Ultraviolet radiation source 104 generates ultraviolet radiation 105.

Examples of dielectric material 90 include polyester, polyethylene, polypropylene, cloth (such as nylon), paper, laminate, glass, and the like. Although referred to as a dielectric material, in some embodiments dielectric material 90 is combined with a conductive layer, an antistatic layer, a conductive region, an antistatic region, and the like. In some embodiments, dielectric material 90 is in the form of a web of sheet stock having an extended length, such as described with reference to FIG. 2. In other embodiments, dielectric material 90 is in the form of a discrete or individual item, such as having a length in a range from about 0.1 meters to about 1 meter and a width from about 0.1 meters to about 1 meter. In some embodiments, dielectric material 90 has a thickness in a range from about 3 micrometers to about 3000 micrometers, and typically from about 10 micrometers to about 1500 micrometers. Some embodiments of dielectric material 90 have a generally planar topography. Other embodiments of dielectric material 90 have a three-dimensional topography.

In some embodiments, charge alteration system 100 includes housing 101. Housing 101 operates to contain or partially contain gas 103 from gas source 102 within housing 101. Some embodiments do not include housing 101. Other embodiments of charge alteration system 100 include housing 101 in the form of a shield, wall, set of walls, cylinder or partial cylinder, sphere or partial sphere, and the like. An example of a housing 101 is a housing of an ultraviolet chamber. In some embodiments, housing 101 includes one or more openings through which dielectric material 90 enters and exits. Some embodiments of housing 101 also include ports or connectors for receiving inputs, such as a gas source port for connecting a hose from gas source 102, an electrical receptacle for receiving electrical energy to power ultraviolet radiation source 104, and other desired ports or connectors.

Gas source 102 is a source of gas 103. In some embodiments, gas source 102 is a gas tank containing pressurized gas or liquid. In other embodiments, gas source 102 is a container including a solid (e.g., dry ice). Gas source 102 is arranged to introduces gas 103 to a region 110 adjacent to dielectric material 90, such as through one or more hoses, tubes, pipes, or other conduits. In some embodiments, gas source 102 is used to purge or partially purge atmosphere from housing 101, and to replace the atmosphere with gas 103. In some embodiments, multiple gas sources 102 are used.

Gas 103 includes one or more gases other than atmosphere. In some embodiments, gas 103 is nitrogen (N₂), carbon dioxide (CO₂), argon (AR), or a combination of these. In yet another embodiment, gas 103 is a noble gas or combination of noble gases. Other gases or combinations of gases are used in other embodiments. In some embodiments, gas 103 is introduced into atmosphere, such that it mixes with the atmosphere adjacent to dielectric material 90.

Ultraviolet radiation source 104 generates ultraviolet radiation 105. Ultraviolet radiation is electromagnetic radiation typically having a wavelength in a range from about 30 nanometers to about 400 nanometers. Examples of ultraviolet radiation sources 104 include various types of lamps, bulbs, or light emitting diodes (LEDs). In addition to ultraviolet radiation 105, some ultraviolet radiation sources 104 also generate additional electromagnetic radiation having wavelengths outside of the ultraviolet spectrum. One example of ultraviolet radiation source 104 is model F450 ultraviolet system including either a “D” bulb or an “H” bulb, manufactured by FUSION UV SYSTEMS, INC® located in Gaithersburg, Md. Ultraviolet radiation source 104 generates ultraviolet radiation 105 and directs the ultraviolet radiation 105 to region 110 including through gas 103 and onto dielectric material 90.

A static charge on dielectric material 90 can be altered using change alteration system 101. To do so, dielectric material 90 is provided including an undesired static charge. Gas 103 is introduced from gas source 102 to a location adjacent to dielectric material 90. Ultraviolet radiation is generated by ultraviolet radiation source 104 and directed to the location adjacent to dielectric material 90. The ultraviolet radiation excites gas 103 and allows gas 103 to interact with the static charge to alter the charge. For example, excess electrons located on dielectric material 90 will be transferred from the dielectric material 90 into gas 103, which then carries the electrons away from dielectric material 90. Therefore, charge alteration system 101 is useful for altering undesired charges present on dielectric material 90. In some embodiments, charge alteration includes removing electrons from dielectric material 90. In other embodiments, charge alteration includes adding electrons to dielectric material 90. In some embodiments, a net charge on dielectric material 90 is neutralized to a potential of less than about 100 volts.

Once undesired charge present on dielectric material 90 has been neutralized, subsequent processing steps can be performed, such as coating, handling, packaging, processing involving potentially flammable materials, and other processing steps. An advantage of altering charge on dielectric material 90 prior to applying a coating is that coating defects that are caused by excess charge are reduced or eliminated. An advantage of altering charge on dielectric material 90 prior to handling (by a human or machine), packaging, or processing involving potentially flammable materials is that is that a risk of static discharge leading to injury or damage is reduced or eliminated. Other embodiments include other features, uses, and advantages.

FIG. 2 is a block diagram of another exemplary charge alteration system 200 for altering a charge on a dielectric material 92. Charge alteration system 200 includes housing 201, gas source 202, and ultraviolet radiation source 204. Gas source 202 is a source of gas 203. Ultraviolet radiation source 204 generates ultraviolet radiation 205. In this embodiment, charge alteration system 200 has been formed around roller 210. Some embodiments also include an optional coating application device 212.

In this example, dielectric material 92 is in the form of a web of sheet stock having an extended length. For example, some embodiments include a web of sheet stock having a length, width, and thickness. The length is typically greater than about 1 meter, often greater than about 10 meters, and sometimes greater than about 100 meters. The width is typically between about 0.25 meters and about 5 meters. The thickness is typically in a range from about 3 micrometers to about 3000 micrometers. Such dielectric materials are sometimes stored in a rolled form, and then unrolled in order to perform processing steps, such as to apply a coating to the dielectric material or to use the dielectric material in a manufacturing process.

Roller 210 is provided to guide dielectric material 92 along a desired path. When dielectric material 92 comes into contact with roller 210, an exchange of surface charge occurs between dielectric material 92 and roller 210. When dielectric material 92 subsequently separates from roller 210, some of the charge remains on dielectric material 92. Charge alteration system 200 is useful in altering the charge, such as to reduce an average charge potential on dielectric material 92. In this way, some embodiments of charge alteration system 200 provide multiple benefits, including a reduced risk of static shock, reduced coating defects, reduced chance of charge tack-down such as in gap dryers and ultraviolet chambers, and improved product cleanliness due to the reduced attraction of dust and other debris.

Gas source 202 is a source of gas 203. In this embodiment, gas 203 is introduced into housing 201 to at least partially fill housing 201 with gas 203. In particular, gas 203 disburses from gas source 202 to charge alteration region 209. Charge alteration region 209 is the region in which charge alteration occurs. In this embodiment, charge alteration region 209 is the region between roller 210 and web 92 just beyond the location at which web 92 separates from roller 210. Charge alteration region 209 is arranged at other locations in other embodiments.

Ultraviolet radiation source 204 generates ultraviolet radiation 205 to charge alteration region 209. A benefit of some embodiments of charge alteration system 200 is that it is able to alter charge in areas that would be difficult to access with other charge alteration systems. Some embodiments of ultraviolet radiation source 204 are able to alter charge at any location in which gas 203 and ultraviolet radiation 205 can be provided. For example, charge alteration system 200 introduces gas 203 and ultraviolet radiation 205 into charge alteration region 209. Ultraviolet radiation 205 acts interacts with gas 203 to alter charge present on dielectric material 92, such as to reduce the average charge potential.

The amount that the charge is altered is variable with a number of factors. One factor is the speed at which the dielectric material travels through charge alteration system 200. In general, slower speeds result in a greater reduction of charge on dielectric material 92. Another factor is the intensity of ultraviolet radiation source 204. In general, higher intensity results in a greater reduction of charge on dielectric material 92. The concentration of gas 203 in housing 201 also has an effect on charge alteration. Other factors are further described herein. In some embodiments, charge can be reduced from kilovolts or more to less than 100 volts with charge alteration system 200.

Some embodiments also include coating application device 212. The coating application device 212 applies a coating of any desired material to at least one side of dielectric material 92. Examples of coating application devices 212 include a die, spray applicator, gravure, and the like.

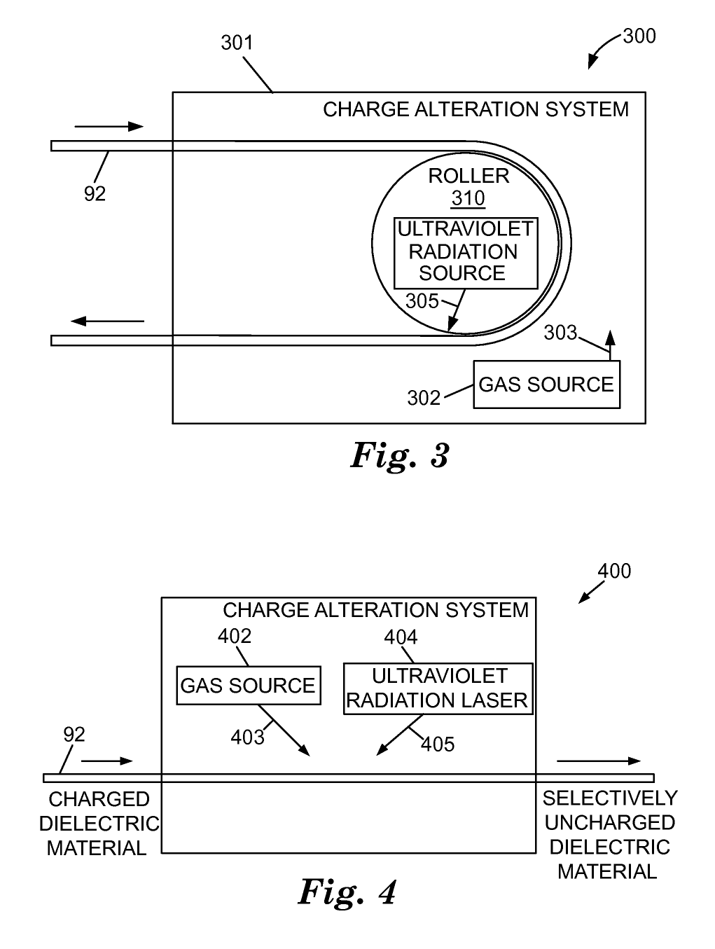

FIG. 3 is a block diagram of another exemplary charge alteration system 300 for altering a charge on a dielectric material 92. Charge alteration system 300 includes housing 301, gas source 302, and ultraviolet radiation source 304. Gas source 302 is a source of gas 303. Ultraviolet radiation source 304 is a generator of ultraviolet radiation 305.

In this embodiment, charge alteration system 300 includes roller 310. Roller 310 is made of a material that is transparent or semi-transparent to ultraviolet radiation. For example, roller 310 is made out of glass or plastic.

Ultraviolet radiation source 304 is located within roller 310. Roller 310 is transparent to ultraviolet radiation 305, such that ultraviolet radiation 305 is able to pass through roller 310.

During use, dielectric material 92 enters charge alteration system 301 and is directed partially around roller 310. When dielectric material 92 makes contact with roller 310, a charge transfer occurs. Some of the transferred charge remains on dielectric material 92 when dielectric material 92 subsequently separates from roller 310. Gas source 302 provides gas 303 within housing 301 which disperses within housing 301. Ultraviolet radiation source 302 generates ultraviolet radiation 303 within roller 310, which passes through roller 310 and onto dielectric material 92. In addition, ultraviolet radiation 305 also irradiates the region between roller 310 and dielectric material 92 where dielectric material 92 is separating from roller 310. Ultraviolet radiation 305 interacts with gas 303 to alter charge on dielectric material 92, such as by exciting the gas 303 atoms or molecules to cause the gas 303 to remove undesired charge.

In some embodiments, charge alteration system 301 acts to remove charge that is present on dielectric material 92 when it enters charge alteration system 301. In another embodiment, dielectric material 92 is substantially neutral when dielectric material 92 enters charge alteration system 301, and exits charge alteration system 301 substantially neutral. In some embodiments, a dielectric material is substantially neutral if the average charge potential is less than 100 volts. In other words, charge alteration system 301 is used in some embodiments to remove charge added by roller 310 or by interaction with another object or material.

An optional coating application device (e.g., 212, shown in FIG. 2) is used in some embodiments of charge alteration system 300, if desired, to apply a coating of material to dielectric material 92.

Other possible embodiments includes two or more charge alteration systems arranged in series adjacent dielectric material 92. Multiple charge alteration systems allow some embodiments to move dielectric material 92 at a higher speed while still attaining a desired charge alteration on the dielectric material 92. Multiple charge alteration systems allow other embodiments to attain greater levels of charge alteration on dielectric material 92.

FIG. 4 is a block diagram of another exemplary charge alteration system 400 for altering a charge on a dielectric material 92. Charge alteration system 400 includes gas source 402 providing gas 403 and ultraviolet radiation laser 404 providing ultraviolet radiation 405.

In the illustrated embodiment, dielectric material 92 enters charge alteration system 400 from the left-hand side and exits at the right-hand side. Prior to entering charge alteration system 400, dielectric material 92 is charged. For example, dielectric material 92 is unrolled from rolled stock, resulting in a charge buildup. As another example, dielectric material 92 is frictionally contacted by another material (e.g., wool), such as by pulling dielectric material 92 across the material. Yet another example involves corona discharge to deposit charge on dielectric material 92.

The charged dielectric material then enters charge alteration system 400. Charge alteration system 400 introduces gas 403 from gas source 402 to surfaces of charge dielectric material 92. Ultraviolet radiation laser 404 generates ultraviolet radiation 405 which is directed to selected locations of charged dielectric material 92 to selectively alter charge at those locations. Motors can be used to guide ultraviolet radiation laser 404, if desired, to irradiate dielectric material 92 in any desired pattern. In this way, dielectric material 92 is selectively uncharged.

Subsequent processing is then performed to make use of the selectively uncharged dielectric material 92. For example, a coating is applied. The charged and uncharged regions of dielectric material 92 interact with the coating differently, thereby creating a pattern, shape, or design in the coating. As another example, toner is applied to dielectric material 92. The toner is attracted to the charged regions. Dielectric material 92 is then contacted to paper or other material to transfer the toner image onto the paper. If desired, heat is used to melt and bond the toner to the paper. Other processing steps are used in other applications.

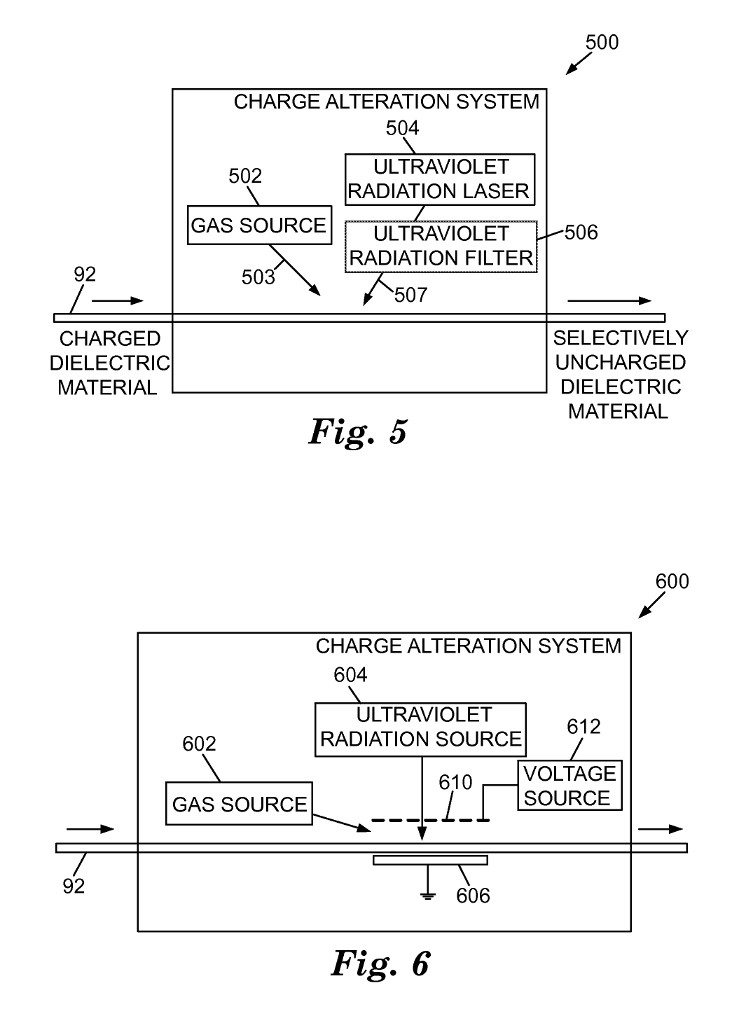

FIG. 5 is a block diagram of another exemplary charge alteration system 500 for altering a charge on a dielectric material 92. Charge alteration system 500 includes gas source 502 providing gas 503, ultraviolet radiation source 504 providing ultraviolet radiation 505, and ultraviolet radiation filter 506. Charge alteration system 500 is similar to charge alteration system 400, shown in FIG. 4, in that it can be used to selectively alter charge on dielectric material 92.

Charge alteration system 500 includes ultraviolet radiation source 504, such as a bulb or lamp that generates ultraviolet radiation 505. To selectively alter charge on dielectric material 92, ultraviolet radiation filter 506 is provided. Ultraviolet radiation filter 506 allows only undesired rays of ultraviolet radiation to pass through and absorbs or reflects undesired rays.

An example of ultraviolet radiation filter 506 is a sheet of transparent material including a non-transparent printed image. Ultraviolet radiation 505 passes through unprinted regions of the transparent material as filtered ultraviolet radiation 507, but does not pass through printed regions. As a result, filtered ultraviolet radiation 507 illuminates dielectric material 92 in a desired pattern. The charge is altered at surface regions of dielectric material 92 where filtered ultraviolet radiation 507 illuminates, and is not altered at surface regions where radiation 507 does not illuminate. In this way the charge is selectively patterned on dielectric material 92.

Another possible example of ultraviolet radiation filter 506 is a liquid crystal display (LCD). The LCD includes pixels arranged in a grid that can be selectively turned on or off. When the pixel is off, ultraviolet radiation passes through the LCD pixel. When a pixel is on, ultraviolet radiation is absorbed and does not pass through. The ultraviolet radiation 505 is directed through the LCD, but filtered ultraviolet radiation 507 passes through only those pixels that are turned off. Filtered ultraviolet radiation 507 illuminates selected regions of dielectric material 92 to alter charge at those locations. Other embodiments include other devices for filtering the ultraviolet radiation.

FIG. 6 is a block diagram of another exemplary charge alteration system 600 for altering a charge on dielectric material 92. Charge alteration system 600 includes gas source 602, ultraviolet radiation source 604, grounded plate 606, screen 610, and voltage supply 612.

It is sometimes desirable to pass dielectric material 92 across a grounded plate 606, a grounded roller, or the like. However, grounded plate 606 interferes with charge alteration by interacting with the charge present on dielectric material 92. For example, if positive charges are present on dielectric material 92, grounded plate 606 will attract the positive charges, causing the field lines from the positive charge to be directed toward grounded plate 606, and away from ultraviolet radiation source 604.

The interference is resolved by providing screen 610 and voltage source 612. Screen 610 is a screen of a conductive material, such as metal. Voltage source 612 is electrically connected to screen 610. Voltage source 612 generates a voltage potential on screen 610 relative to grounded plate 606. The voltage may be either positive or negative or ground, and in some embodiments the voltage switches between positive and negative and ground.

The voltage potential between screen 610 and grounded plate 606 attracts the charge on dielectric material 92, thereby redirecting field lines (not shown) to point toward screen 610. Ultraviolet radiation source 604 generates ultraviolet radiation 605 that passes through screen 610 and interacts with gas 606 to alter the charge on dielectric material 92.

### Examples

### The following non-limiting examples illustrate various embodiments according to the present disclosure.

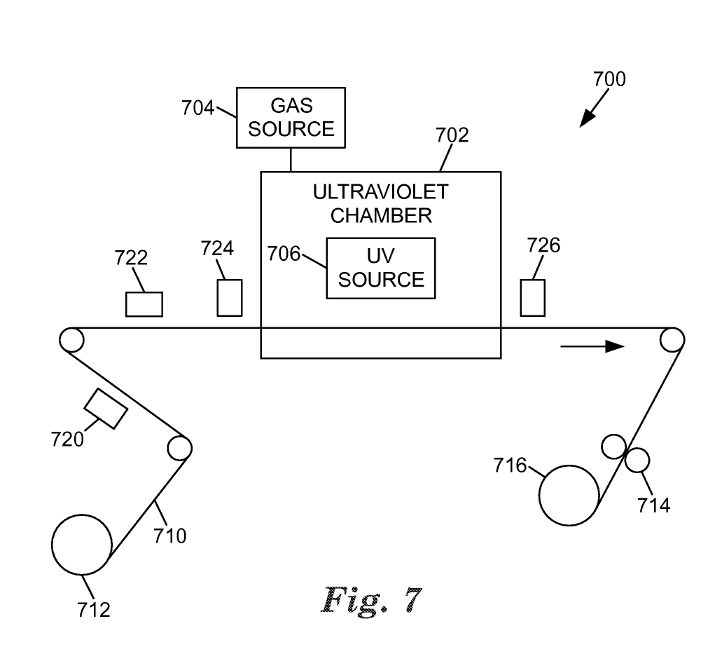

FIG. 7 is a schematic block diagram of a test system 700 that was used for conducting experiments described below. Test system 700 included ultraviolet chamber 702, gas source 704, and ultraviolet source 706. Dielectric material 710 was unrolled from rolled stock 712 and directed along a path through ultraviolet chamber 702, through pacer roll 714, and re-rolled into roll 716.

In the tests described below, dielectric material 710 was Polyethylene terephthalate (PET) having a thickness of about 0.002 inches (about 51 micrometers) and a width of about six inches.

Along the path of dielectric material 710 were various instruments. The instruments included nuclear bar 720, corotron 722, input voltage meter 724, and output voltage meter 726. Dielectric material 710 was unrolled from rolled stock 712 and then passed by nuclear bar 720. Unrolling dielectric material 710 generated a large amount of charge on dielectric material 710. Nuclear bar 720 was used to reduce the charge present on dielectric material 710. A charge was then applied to dielectric material 710 with corotron 722. Corotron 722 was a dual-wire corotron, powered by either a +15 KV/20 mA Glassman DC power supply through a 50 MOhm resistor or a −20 kV/15 mA Glassman DC power supply through a 100 MOhm resistor. The charge applied to dielectric material 710 was generally about 2 kV (as measured by input voltage meter 724).

Prior to entering ultraviolet chamber 702, input voltage meter 724 was used to measure the free span potential of dielectric material 724. Input voltage meter 724 was a 3M 718 static meter. Dielectric material 710 then passed through ultraviolet chamber 702 where it was exposed to a gas from gas source 704 and ultraviolet radiation from ultraviolet source 706. Upon exiting ultraviolet chamber 702, output voltage meter 726 was used to again measure the free span potential of dielectric material 724. Meter 726 was a 3M 718 static meter. Meters 724 and 726 were connected to a Tektronix TDS 3034B oscilloscope that collected the data.

Dielectric material 710 then passed through pacer roll 714, which controlled the speed of dielectric material 710. Dielectric material 710 was then re-rolled into roll 716.

### Example 1 -Nitrogen

In this test, ultraviolet chamber 702 was supplied with nitrogen (N₂) gas from gas source 704. UV source 706 was either a Fusion F450 D-type bulb or an H-type bulb as specified below, and was powered by a Fusion P115 variable power supply (300 Watts/inch at 100% power). The input and output potentials were measured by input meter 724 and output meter 726, respectively.

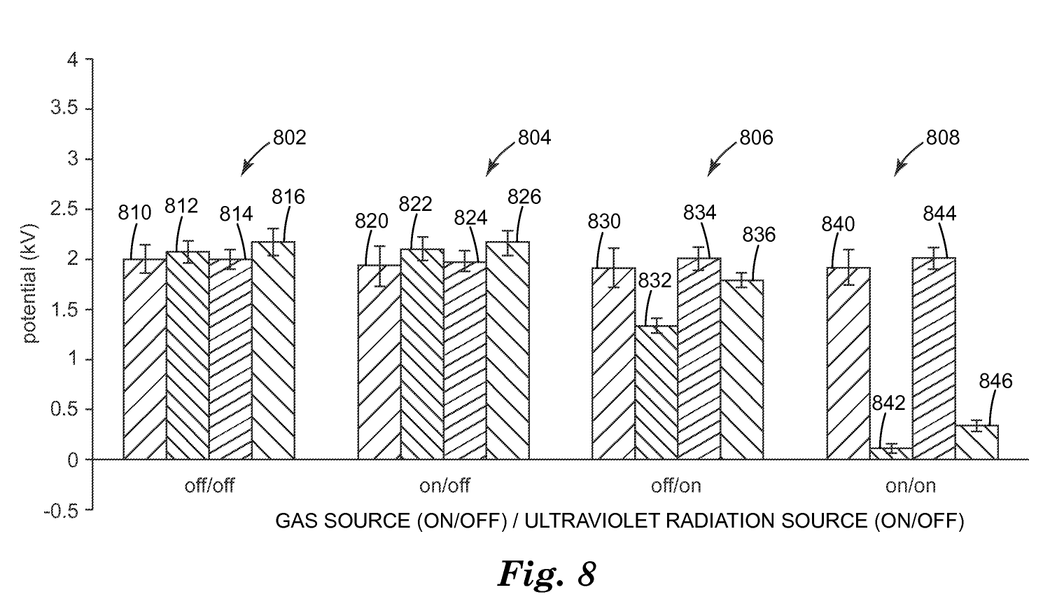

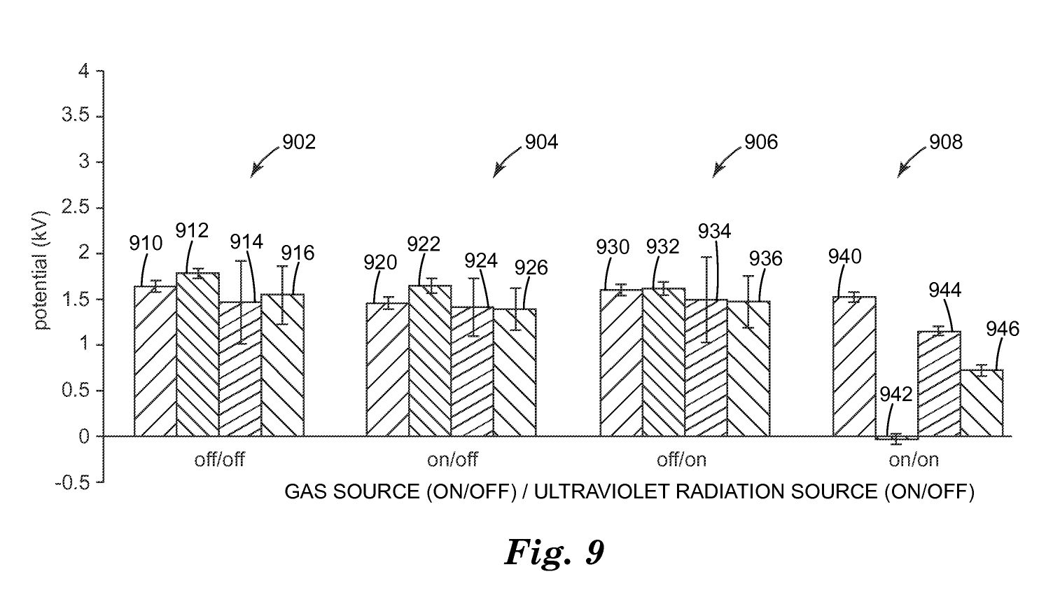

FIGS. 8 and 9 are bar graphs illustrating test results for positively charged (FIG. 8) and negatively charged (FIG. 9) dielectric material. In the tests illustrated, various conditions were tested involving the state of the gas source (on or off) and the state of the ultraviolet radiation source (on or off). Tests were also conducted in which the dielectric material moved through the ultraviolet chamber at a rate of 10 meters/minute and a rate of 25 meters/minute.

FIG. 8 illustrates tests that were conducted using a positively charged dielectric material as the input. The input potential and the output potential are illustrated. The “error bars” represent the time-averaged standard deviation of the input and output potentials and do not represent actual errors in the measurements. The input potential was typically about 2 kV. The graphs illustrate the results of case 802, case 804, case 806, and case 808. During case 802 the gas source (N₂) was off and the ultraviolet radiation source (a D-type bulb) was off. During case 804 the gas source was on and the ultraviolet radiation source was off. During case 806 the gas source was off and the ultraviolet radiation source was on. During case 808 both the gas source and the ultraviolet radiation source were on. In these tests, when the ultraviolet radiation source is “on”, it is operating at full (100%) power.

In each case (802, 804, 806, and 808) there were two tests conducted. The first case (represented by the left two bars of each case) involved a dielectric material speed of 10 meters/minute. The second case (represented by the right two bars of each case) involved a dielectric material speed of 25 meters/minute.

Case 802 illustrates measurements 810, 812, 814, and 816. Measurements 810 and 814 are the measurements of the incoming potentials and measurements 812 and 816 are measurements of the outgoing potentials after passing through the ultraviolet chamber. Average potentials are shown. In this case, in which both the gas source and the ultraviolet source were off, the outgoing potential was generally about the same as the incoming potential.

Case 804 illustrates embodiments 820, 822, 824, and 826. Measurements 820 and 824 are the measurements of incoming potentials and measurements 822 and 826 are measurements of outgoing potentials. In this case, in which the gas source was on but the ultraviolet source was off, the outgoing potential was generally about the same as the incoming potential.

Case 806 illustrates measurements 830, 832, 834, and 836. Measurements 830 and 834 are the measurements of incoming potentials and measurements 832 and 836 are measurements of outgoing potentials. In this case, in which the gas source was off and the ultraviolet radiation source was on, some decrease in outgoing potential was measured, but measurements 832 and 836 remained above 1 kV.

Case 808 illustrates measurements 840, 842, 844, and 846. Measurements 840 and 844 are the measurements of incoming potentials and measurements 842 and 846 are measurements of outgoing potentials. In this case, in which both the gas source and the ultraviolet radiation source were on, a substantial decrease in outgoing potential was measured by measurements 842 and 846. Specifically, in the first test (with a 10 meter/minute dielectric material speed) the incoming potential (measurement 840) was about 2 kV and the outgoing potential (measurement 842) was about 0.1 kV. In the second test (with a 25 meter/minute dielectric material speed) the incoming potential (measurement 842) was about 2 kV and the outgoing potential (measurement 844) was about 0.3 kV.

Therefore, it was found that reduction in charge for positively charged dielectric materials was most effective when the gas source was turned on and the ultraviolet radiation source was also turned on.

FIG. 9 illustrates tests that were conducted using a negatively charged dielectric material as the input. The input potential and the output potential are illustrated. The input potential was between about 1 kV and 2 kV. The graphs illustrate the results of case 902, case 904, case 906, and case 908. During case 902 the gas source (N₂) was off and the ultraviolet radiation source (a D-type bulb) was off. During case 904 the gas source was on and the ultraviolet radiation source was off. During case 906 the gas source was off and the ultraviolet radiation source was on. During case 908 both the gas source and the ultraviolet radiation source were on. In these tests, when the ultraviolet radiation source is “on”, it is operating at full (100%) power.

In each case (902, 904, 906, and 908) there were two tests conducted. The first case (represented by the left two bars of each case) involved a dielectric material speed of 10 meters/minute. The second case (represented by the right two bars of each case) involved a dielectric material speed of 25 meters/minute.

Case 902 illustrates measurements 910, 912, 914, and 916. Measurements 910 and 914 are the measurements of the incoming potentials and measurements 912 and 916 are measurements of the outgoing potentials after passing through the ultraviolet chamber. Average potentials are shown. In this case, in which both the gas source and the ultraviolet source were off, the outgoing potential was generally about the same as the incoming potential.

Case 904 illustrates measurements 920, 922, 924, and 926. Measurements 920 and 924 are the measurements of incoming potentials and measurements 922 and 926 are measurements of outgoing potentials. In this case, in which the gas source was on but the ultraviolet source was off, the outgoing potential was generally about the same as the incoming potential.

Case 906 illustrates measurements 930, 932, 934, and 936. Measurements 930 and 934 are the measurements of incoming potentials and measurements 932 and 936 are measurements of outgoing potentials. In this case, in which the gas source was off and the ultraviolet radiation source was on, the outgoing potential was generally about the same as the incoming potential.

Case 908 illustrates measurements 940, 942, 944, and 946. Measurements 940 and 944 are the measurements of incoming potentials and measurements 942 and 946 are measurements of outgoing potentials. In this case, in which both the gas source and the ultraviolet radiation source were on, a substantial decrease in outgoing potential was measured by measurement 942 and some decrease was measured by measurement 946. Specifically, in the first test (with a 10 meter/minute dielectric material speed) the incoming potential (measurement 940) was about 1.5 kV and the outgoing potential (measurement 942) was about 0 kV (note that measurement 942 was even slightly positive). In the second test (with a 25 meter/minute dielectric material speed) the incoming potential (measurement 942) was about 1.1 kV and the outgoing potential (measurement 944) was about 0.7 kV.

Therefore, it was found that reduction in charge for positively charged dielectric materials was most effective when the gas source was turned on and the ultraviolet radiation source was also turned on. A slower speed of the dielectric material was also more effective.

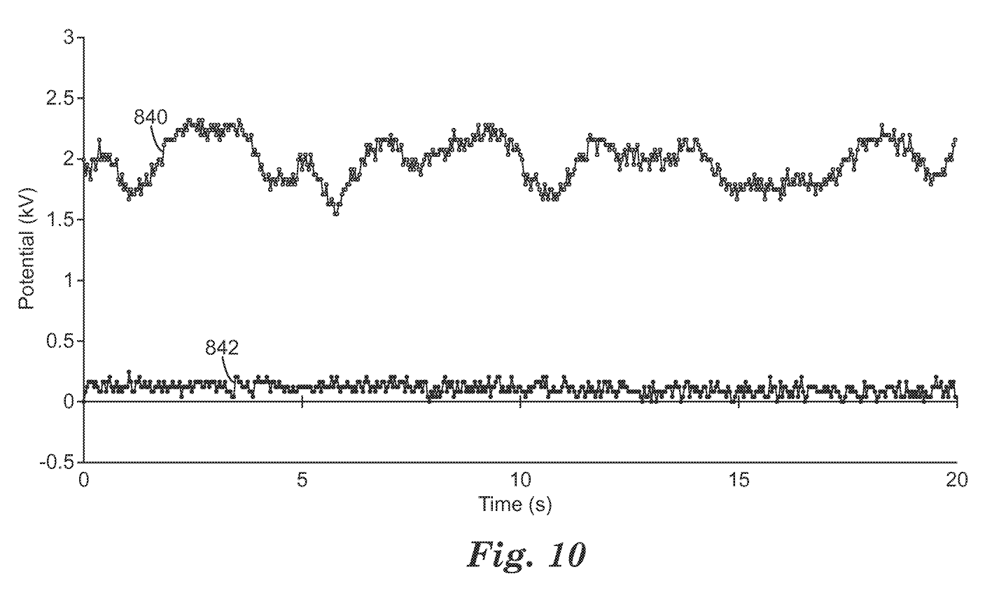

FIG. 10 is a timeline illustrating the test results of measurements 840 and 842 over a twenty second period. Measurements 840 and 842 were conducted with the gas source (N2) on and the ultraviolet radiation source (D-type bulb) on. The average incoming potential (measurement 840) was about 2 kV with a standard deviation of about 0.171 and the average outgoing potential (measurement 842) was about 0.1 kV with a standard deviation of about 0.047. Therefore, it is possible to reduce positive charge present on a dielectric material to about 100 volts. Slower speeds (e.g., increased exposure time) may further reduce the charge.

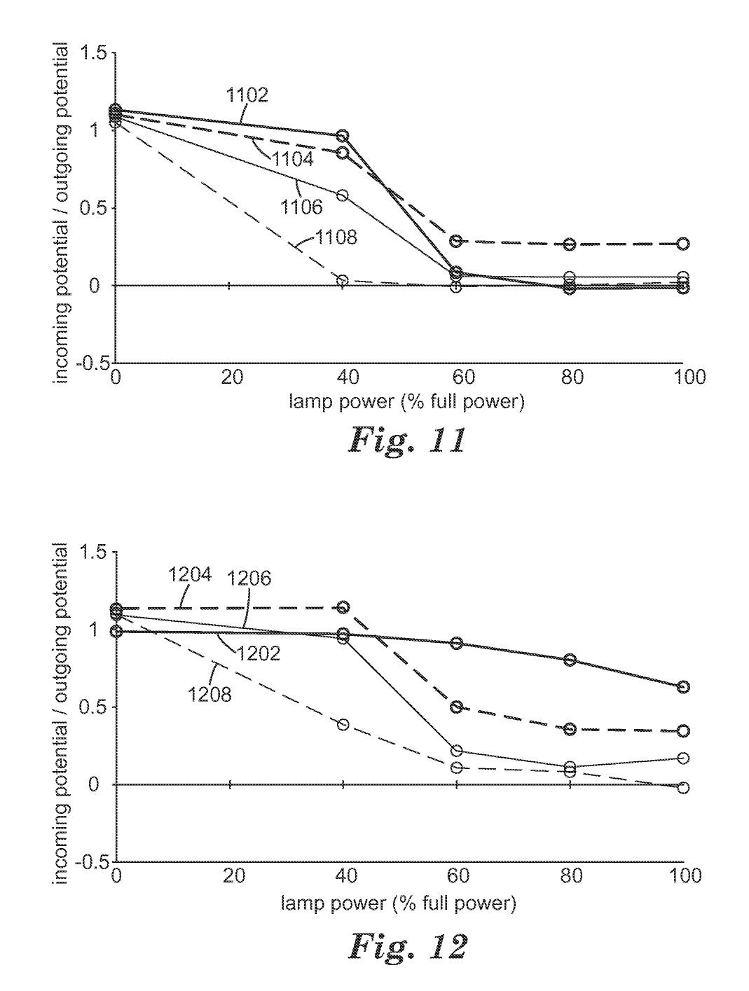

The effect that lamp power had on charge is illustrated in FIGS. 11 and 12. In both graphs the x-axis is incoming potential divided by outgoing potential and the y-axis is the percentage of lamp power (as a percent of full power). Incoming potentials were similar to cases 802 and 902.

FIG. 11 is a graph illustrating tests in which dielectric material 710 was passed through ultraviolet chamber 702 at a rate of 10 meters/minute. The graph includes lines 1102, 1104, 1106, and 1108. Lines 1102 and 1104 are test results using a negatively charged dielectric material (e.g., the corotron powered by the negative 20 kV/15 mA Glassman DC power supply) and lines 1106 and 1108 are test results using a positively charged dielectric material (e.g., the corotron powered by the positive 15 kV/20 mA Glassman DC power supply). Lines 1102 and 1106 are test results using a D-type bulb and lines 1104 and 1108 are test results using an H-type bulb.

Generally, all tests showed a decrease in charge with increased lamp power. The H-type bulb worked best for positively charged dielectric material, while the D-bulb worked best for negatively charged dielectric material.

FIG. 12 is a graph illustrating tests in which dielectric material 710 was passed through ultraviolet chamber 702 at a rate of 25 meters/minute. The graph includes lines 1202, 1204, 1206, and 1208. Lines 1202 and 1204 are test results using a negatively charged dielectric material and lines 1206 and 1208 are test results using a positively charged dielectric material. Lines 1202 and 1206 are test results using a D-type bulb and lines 1204 and 1208 are test results using an H-type bulb.

Generally, all tests showed a decrease in charge with increased lamp power. The H-type bulb worked better for both positively and negatively charged dielectric material. In addition, negative charge was reduced more than positive charge.

### Example 2-Carbon Dioxide

In this test, ultraviolet chamber 702 was supplied with carbon dioxide (CO₂) gas from gas source 704 and equipped with a Fusion F450 H-type bulb. The input and output potentials were measured by input meter 724 and output meter 726, respectively. Incoming potentials were similar to cases 802 and 902.

The results of these tests were similar to the results of the nitrogen tests (described above), except that the degree of charge reduction on the dielectric material was less with carbon dioxide.

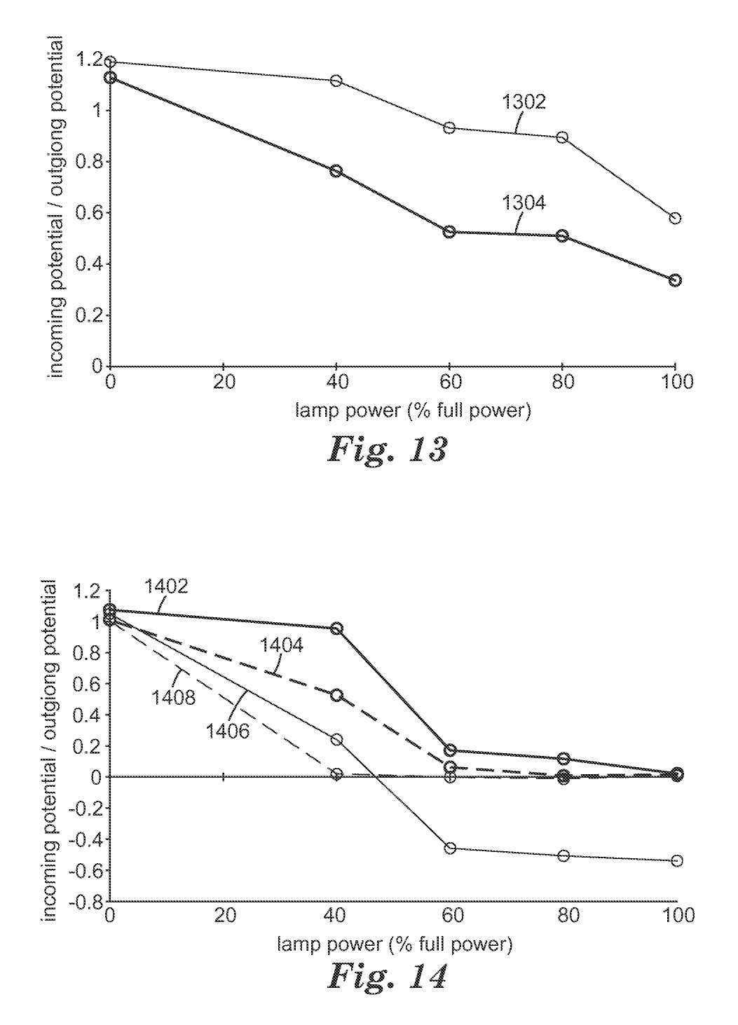

FIG. 13 is a graph illustrating tests in which dielectric material 710 was passed through ultraviolet chamber 702 at a rate of 10 meters/minute. In the graph the x-axis is incoming potential divided by outgoing potential and the y-axis is the percentage of lamp power (as a percent of full power).

The graph includes lines 1302 and 1304. Line 902 is the test result for negatively charged dielectric material. Line 904 is the test result for positively charged dielectric material. As shown, charge generally decreased with increased lamp power. In addition, line 904 shows that positive charge was reduced more on dielectric material than negative charge.

### Example 3-Argon

In this test, ultraviolet chamber 702 was supplied with argon (AR) gas from gas source 704 and equipped with a Fusion F450 D-type bulb or an H-type bulb as specified below. The input and output potentials were measured by input meter 724 and output meter 726, respectively. Incoming potentials were similar to cases 802 and 902.

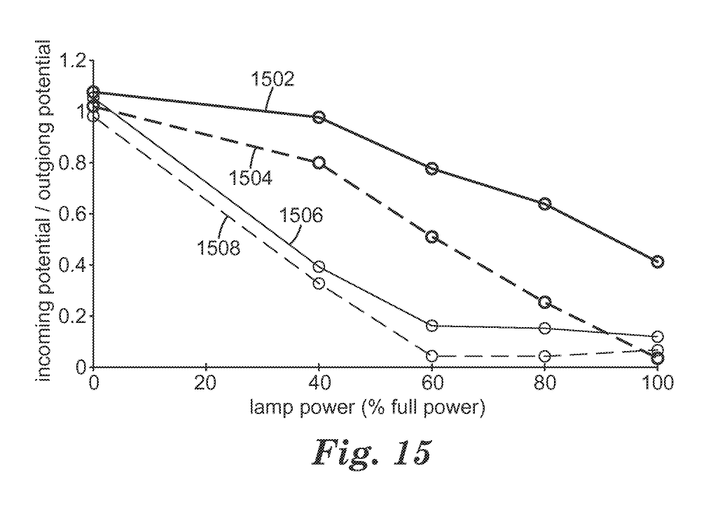

The effect that lamp power had on charge is illustrated in FIGS. 14 and 15. In both graphs the x-axis is incoming potential divided by outgoing potential and the y-axis is the percentage of lamp power (as a percent of full power).

FIG. 14 is a graph illustrating tests in which dielectric material 710 was passed through ultraviolet chamber 702 at a rate of 10 meters/minute. The graph includes lines 1402, 1404, 1406, and 1408. Lines 1402 and 1404 are test results using a negatively charged dielectric material (e.g., the corotron powered by the negative 20 kV/15 mA Glassman DC power supply) and lines 1406 and 1408 are test results using a positively charged dielectric material (e.g., the corotron powered by the positive 15 kV/20 mA Glassman DC power supply). Lines 1402 and 1406 are test results using a D-type bulb and lines 804 and 808 are test results using an H-type bulb.

Generally, all tests showed a decrease in charge with increased lamp power. The H-type bulb worked best for both positively and negatively charged dielectric material. It was also found that a negative charge could be applied to a previously positively charged dielectric material using a D-type bulb. Therefore, charge alteration not only includes charge reduction but also charge addition.

FIG. 15 is a graph illustrating tests in which dielectric material 710 was passed through ultraviolet chamber 702 at a rate of 25 meters/minute. The graph includes lines 1502, 1504, 1506, and 1508. Lines 1502 and 1504 are test results using a negatively charged dielectric material and lines 1506 and 1508 are test results using a positively charged dielectric material. Lines 1502 and 1506 are test results using a D-type bulb and lines 1504 and 1508 are test results using an H-type bulb. Generally, all tests showed a decrease in charge with increased lamp power. The H-type bulb worked better for both positively and negatively charged dielectric material. In addition, negative charge was reduced more than positive charge.

### Example 4

A summary of test results is provided below. In each test, the ultraviolet radiation source was used at full power. Various gas sources were used, as indicated.

Table 1 provides the test results using initially positively charged dielectric material moving at 10 meters/minute.

TABLE 1
Incoming Potential/Outgoing Potential

| | Nitrogen (N₂) | Carbon Dioxide (CO₂) | Argon (AR) |
|---|---|---|---|
| D-type bulb | 5.5% | (Not tested) | −54% |
| H-type bulb | 2.0% | 34% | 0.6% |

Table 2 provides the test results using initially negatively charged dielectric material moving at 10 meters/minute.

TABLE 2
Incoming Potential/Outgoing Potential

| | Nitrogen (N₂) | Carbon Dioxide (CO₂) | Argon (AR) |
|---|---|---|---|
| D-type bulb | 1.5% | (Not tested) | 2.1% |
| H-type bulb | 27% | 58% | 1.4% |

Table 3 provides the test results using initially positively charged dielectric material moving at 25 meters/minute.

TABLE 3
Incoming Potential/Outgoing Potential

| | Nitrogen (N₂) | Argon (AR) |
|---|---|---|
| D-type bulb | 17% | 12% |
| H-type bulb | −2.2% | 6.7% |

Table 4 provides the test results using initially negatively charged dielectric material moving at 25 meters/minute.

TABLE 4
Incoming Potential/Outgoing Potential

| | Nitrogen (N₂) | Argon (AR) |
|---|---|---|
| D-type bulb | 63% | 41% |
| H-type bulb | 36% | 3.5% |

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A charge alteration system for altering a charge on a dielectric material, the system comprising:
a gas source for introducing a gas to a location adjacent the dielectric material such that the gas has a greater concentration at the location than in atmosphere; and
an ultraviolet radiation source for generating ultraviolet radiation and directing the ultraviolet radiation to the location; wherein the ultraviolet radiation interacts with the gas and the dielectric material to alter the charge on the dielectric material.

2. The charge alteration system of claim 1, wherein the ultraviolet radiation interacts with the gas and the dielectric material to reduce an absolute value of an average charge potential from an initial value of greater than about 1000 volts to less than about 150 volts.

3. The charge alteration system of claim 1, wherein the gas source contains a gas selected from the group consisting of nitrogen, carbon dioxide, argon, and a noble gas.

4. The charge alteration system of claim 1, wherein the ultraviolet radiation source comprises a laser, optionally wherein the laser is arranged to selectively alter the charge on the dielectric material in a predetermined pattern to prepare the dielectric material for subsequent processing.

5. (canceled)

6. The charge alteration system of claim 1, further comprising a filter arranged to filter the ultraviolet radiation to selectively direct the ultraviolet radiation in a predetermined pattern on the dielectric material to prepare the dielectric material for subsequent processing.

7. The charge alteration system of claim 1, wherein the ultraviolet radiation source generates electromagnetic radiation having a wavelength in a range from about 30 nanometers to about 400 nanometers.

8. A method of altering charge on a dielectric material, the method comprising:
obtaining the dielectric material;
introducing a gas to a region adjacent the dielectric material such that the gas has a greater concentration at the region than in atmosphere;
irradiating the region and the dielectric material with ultraviolet radiation; and
altering charge on the dielectric material while irradiating the dielectric material.

9. The method of claim 8, wherein the dielectric material is selected from the group consisting of polyester, polyethylene, polypropylene, cloth, paper, laminate, and glass.

10. The method of claim 8, wherein the dielectric material has a length in a range from about 1 meter to about 100 meters, a width in a range from about 0.25 meters to about 5 meters, and a thickness in a range from about 3 micrometers to about 3000 micrometers.

11. The method of claim 8, wherein obtaining the dielectric material comprises obtaining a charged dielectric material, and wherein altering charge on the dielectric material comprises reducing charge on the dielectric material.

12. The method of claim 8, wherein the charged dielectric material has a potential greater than 1000 volts and wherein reducing charge on the dielectric material comprises reducing the potential to less than 150 volts.

13. The method of claim 12, wherein reducing charge on the dielectric material comprises reducing the potential to less than 100 volts.

14. The method of claim 8, wherein altering charge is performed in a predetermined pattern to form a first region having a first charge potential and a second region have a second charge potential, wherein the first charge potential is greater than the second charge potential.

15. The method of claim 8, wherein obtaining the dielectric material comprises:
unrolling a portion of a rolled dielectric material; and
feeding the unrolled portion of the dielectric material through the region with at least one roller; and wherein altering charge comprises reducing charge on the dielectric material.

16. The method of claim 15, wherein the roller is electrically connected to ground, and further comprising feeding the unrolled portion past a screen while altering charge.

17. The method of claim 15, wherein feeding the unrolled portion comprises moving the unrolled portion at a speed in a range from about 10 meters per minute to about 25 meters per minute.

18. A charge alteration system comprising:
a dielectric material path for receiving a dielectric material;
a gas source containing a gas, the gas source arranged to supply the gas to a location adjacent the dielectric material path to increase a concentration of the gas at the location; and
an ultraviolet radiation source for radiating the location with ultraviolet radiation to excite the gas and to alter charge on the dielectric material.

19. The charge alteration system of claim 18, wherein the gas is selected from the group consisting of nitrogen and argon.

20. The charge alteration system of claim 18, wherein the ultraviolet radiation source is a bulb, lamp, or light emitting diode.

21. The charge alteration system of claim 18, wherein altering charge comprises increasing a magnitude of a charge potential on the dielectric material.
